(19) United States
(12) Patent Application Publication
(10) Pub. No.: US 2006/0136874 A1
(43) Pub. Date: Jun. 22, 2006

(54) Ring transition bypass

(76) Inventor: Frank L. Berry, North Plains, OR (US)

Correspondence Address: Grossman, Tucker, Perreault & Pfleger, PLLC;c/o PortfolioIP, P.O. Box 52050, Minneapolis, MN, 55402, US

(21) Appl. No.: 11/020,962

(22) Filed: Dec. 22, 2004

(51) Int. Cl. G06F 9/44

(52) U.S. Cl. 717/120

(57) ABSTRACT

A method for bypassing a ring transition according to one embodiment may include: substituting an instruction from an application program that would cause a ring transition with a trigger signal, the application program running at a first ring level on a computer system, the instruction requesting an operation, the trigger signal comprising data representative of the operation; and providing the trigger signal to an integrated circuit, the integrated circuit signaling software running at a second ring level on a host processor of the computer system, the software providing the operation requested by the application program, the second ring level having a higher priority level than the first ring level. Of course, many alternatives, variations, and modifications are possible without departing from this embodiment.

### FIELD

This disclosure relates to ring transition bypass.

### BACKGROUND

A computer system may run a variety of software applications and programs from user applications, to server-type applications which may provide services for user applications, to operating systems which may support all other applications and programs running on the computer system. The computer system may also include a host processor. The host processor may include privilege level protection which may be used to selectively protect various portions of the operating system and other software, e.g., device drivers, from application programs.

The privilege level protection may be based on a hierarchy of different privilege levels or ring levels. A ring level may be a priority level at which the host processor operates when running certain code or programs or when controlling or servicing various hardware devices. Ring 0 may be the most privileged level and Ring 3 may be the least privileged level. One manner for assigning privilege in a computer system is to assign the operating system kernel to Ring 0, original equipment manufacturer software (e.g., device drivers) to Ring 2, and user applications to Ring 3. Hence, Ring 0 may sometimes be referred to as the “kernel-mode” of operation and Ring 3 may be referred to as the “user-mode” of operation.

If a lesser privileged ring level application, e.g., a user-mode application, needs to communicate with a higher privileged ring level program, e.g., kernel-mode software, the user-mode application may make a system call to the kernel-mode software using special procedure that requires a “ring transition” from one privilege level to another. Such ring transitions may result in undesirable latency. For example, the time to perform a system call requiring a ring transition from a user-mode application to a higher privileged Input/Output driver stack may consume 5,300 nanoseconds (ns) of processor time. In addition, the system call and ring transition may pollute cache memory of the host processor with system call code. For level-1 (L1) cache memory that is built onto the host processor chip itself, this may contribute to an increase in L1 cache misses. Furthermore, as clock rate speeds of host processors improve, there is unfortunately not a related linear improvement in the time it takes for system calls and ring transitions. Hence, such system calls and ring transitions can prove to be a bottleneck for various processor intensive functions such as on-processor network protocol processing for permitting communication between various devices coupled to a network.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating an integrated circuit of FIG. 1 in conjunction with software running in user-mode and kernel-mode; and

FIG. 3 is a flow chart illustrating operations according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

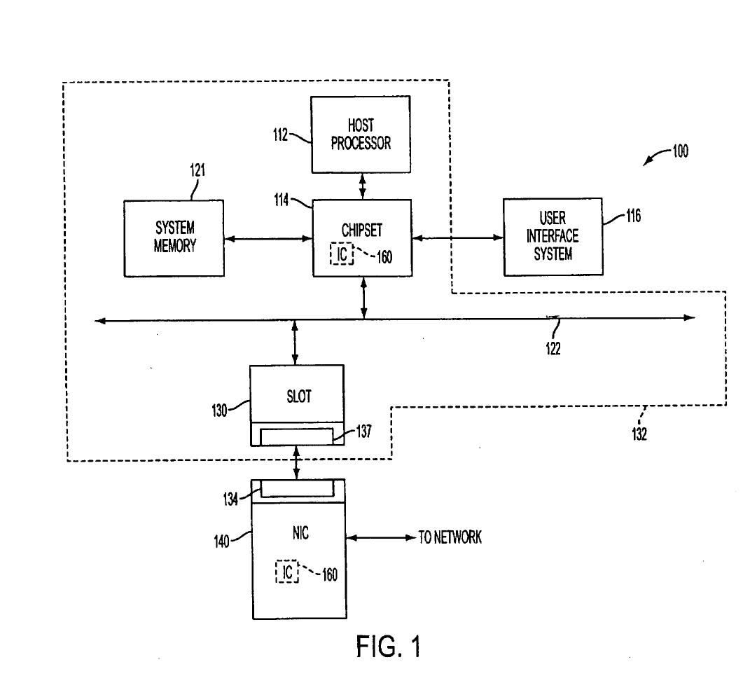

FIG. 1 illustrates a computer system 100 consistent with an embodiment. The system 100 may include a host processor 112, a bus 122, a user interface system 116, a chipset 114, system memory 121, a card slot 130, and a network interface card (NIC) 140. The host processor 112 may include one or more processors known in the art such as an Intel® Pentium IV processor commercially available from the Assignee of the subject application. The bus 122 may include various bus types to transfer data and commands. For instance, the bus 122 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 122 may alternatively comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The user interface system 116 may include one or more devices for a human user to input commands and/or data and/or to monitor the system, such as, for example, a keyboard, pointing device, and/or video display. The chipset 114 may include a host bridge/hub system (not shown) that couples the processor 112, system memory 121, and user interface system 116 to each other and to the bus 122. The chipset 114 may include one or more integrated circuit chips, such as those selected from integrated circuit chipsets commercially available from the Assignee of the subject application (e.g., graphics memory and I/O controller hub chipsets), although other integrated circuit chips may also, or alternatively be used. System memory 121 may include one or more machine readable storage media such as random-access memory (RAM), dynamic RAM (DRAM), static RAM (SRAM), magnetic disk, and/or any other device that can store information.

When the NIC 140 is properly inserted into the slot 130, connectors 134 and 137 become electrically and mechanically coupled to each other. When connectors 134 and 137 are so coupled to each other, the NIC 140 becomes electrically coupled to bus 122 and may exchange data and/or commands with system memory 121, host processor 112, and/or user interface system 116 via bus 122 and chipset 114.

Alternatively, without departing from this embodiment, the operative circuitry of the NIC 140 may be included in other structures, systems, and/or devices. These other structures, systems, and/or devices may be, for example, in the motherboard 132, and coupled to the bus 122. These other structures, systems, and/or devices may also be, for example, comprised in chipset 114. The NIC 140 may act as an intermediary between the system 100 and a network to permit communication to and from the system 100 and other nodes coupled to the network. As such, the NIC 140 may pass data and/or commands to and from the network to the system 100. Communication via the network may take place using any variety of communication protocols. One such communication protocol may be an Ethernet protocol. The Ethernet protocol may comply or be compatible with the Ethernet standard published by the Institute of Electrical and Electronics Engineers (IEEE) titled the IEEE 802.3 Standard, published in March, 2002 and/or later versions of this standard.

The system 100 may include any variety of machine readable media such as system memory 121. Machine readable program instructions may be stored in any variety of such machine readable media so that when the instructions are executed by a machine, e.g., by the processor 112 in one instance, or circuitry in another instance, or a dedicated processor, etc., it may result in the machine performing operations described herein.

The system 100 may run a variety of software applications and programs from user-applications, to server-type applications which may provide services for applications, to operating systems which may support all other applications and programs running on the system 100. The host processor 112 may include privilege level protection which may be used to selectively protect various portions of the operating system and other software, e.g., device drivers from lower privileged applications. The privilege level protection may be based on a hierarchy of different privilege levels or ring levels such as Ring levels 0, 2, and 3.

The operating system kernel may be assigned the highest priority level or Ring 0 while user applications may be assigned the lowest priority level or Ring 3. Hence, Ring 0 may be referred to as the “kernel-mode” of operation and Ring 3 may be referred to as the “user-mode” of operation. There are times when the user-mode application may initiate an instruction that requests an operation to be performed in kernel-mode that would otherwise require a ring transition. The system 100 may substitute the instruction from the application program that would otherwise cause the ring transition with a trigger signal to bypass the ring transition, and signal software running on the host processor 112 to perform the operation requested by the instruction.

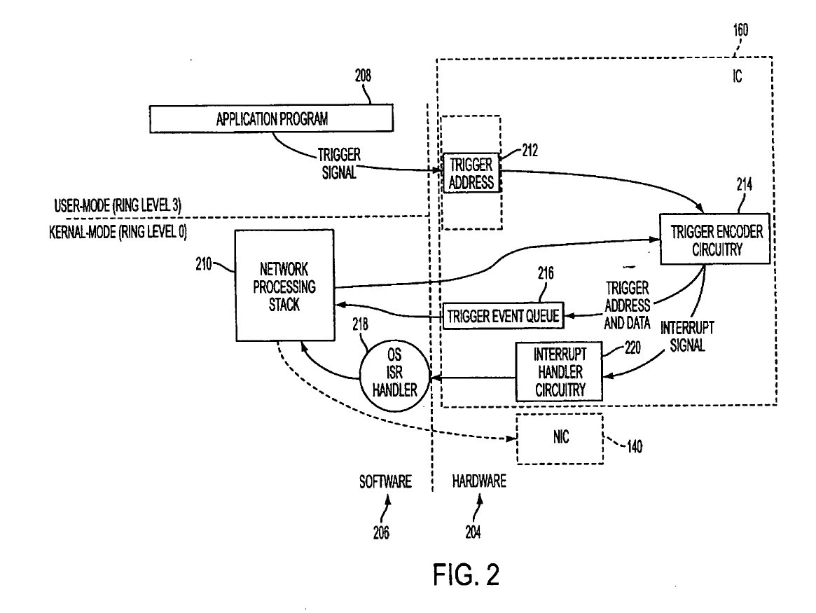

FIG. 2 illustrates one embodiment capable of implementing a ring transition bypass method to signal software running on the host processor 112. The embodiment may include hardware 204 and software 206. The hardware 204 may include an integrated circuit (IC) 160. As used herein, an “integrated circuit” or IC means a semiconductor device and/or microelectronic device, such as, for example, a semiconductor integrated circuit chip. The IC 160 may be located in a variety of locations in the system 100 including a separate IC coupled to the bus 122 or it may be integrated as part of another chip such as the chipset 114 as illustrated in FIG. 1. Alternatively, the functionality of the IC 160 may be integrated into the host processor 112 or the NIC 140.

The software may include an application program 208 running in a user-mode, e.g., running at ring level 3. The application program 208 may produce an instruction that requests an operation to be performed by a higher privileged application that would normally cause a system call and associated ring transition. This instruction may be replaced with a trigger signal to therefore bypass the ring transition. One way of replacing the instruction with the trigger signal is to directly program the application program itself to initiate a trigger signal rather than the system call. Alternatively to performing this programming detail in the application program itself, the application program may link to additional software that both identifies the instruction from the application program and replaces it with the trigger signal. Yet another way to replace the instruction with a trigger signal is to develop a software library related to a particular platform on the computer system 100. The application program 208 may then be linked to and access the software library which would serve to replace particular system calls with associated trigger signals. The trigger signal may be provided to the IC 160 in the embodiment of FIG. 2. The trigger signal may contain data representative of the requested operation and data identifying the particular application program that made the request.

In response to the trigger signal, the IC 160 may signal software running in kernel-mode to perform the operation requested by the application program. In the embodiment illustrated in FIG. 2, the IC 160 may signal the software running in kernel mode via an interrupt signal to interrupt the software running in kernel-mode. The IC 160 may include trigger encoder circuitry 214, a trigger event queue 216, and interrupt handler circuitry 220. As used herein, “circuitry” may comprise, for example, singly or in any combination, hardwired circuitry, programmable circuitry, state machine circuitry, and/or firmware that stores instructions executed by programmable circuitry. Although the trigger event queue 216 is illustrated as being part of the IC 160, the queue 216, as an ordered collection of data, may be located in any variety of memory such as system memory 121 or in cache memory of the host processor 112 or in cache memory of some other processor.

The trigger signal may be mapped into a unique trigger address 212 identifying the particular application that generated the trigger signal. Although only one application program 208 is illustrated for clarity, a plurality of application programs may make requests that would otherwise require a ring transition that are replaced by an associated plurality of trigger signals. One application may also make a plurality of requests. Each trigger signal may be mapped into an associated unique trigger address particularly identifying the application that generated the trigger signal. The trigger encoder circuitry 214 may encode the trigger address and any other additional trigger data such as the requested operation into a data element and transfer the data element to the trigger event queue 216. The trigger event queue 216 may therefore contain a plurality of ordered data elements from an associated plurality of trigger signals from one or more application programs.

The trigger encoder circuitry 214 may also generate an interrupt signal to be provided to an interrupt handler circuitry 220. The interrupt handler circuitry 220 may be moderated via a software interrupt service routine (ISR) 218. The interrupt service routine 218 may moderate among a plurality of interrupt requests via software adjusted controls using coalescing and moderation techniques known to those skilled in the art. The interrupt service routine 218 may then interrupt software running on the host processor 112 to perform the operation requested by the application program. The software running on the host processor may be running in kernel-mode, e.g., at ring level 3.

The software running on the host processor may be network processing stack software 210 to perform an input/output operation to initiate and complete message transmission and reception in on-processor protocol processing situations as requested by the application program that initiated the trigger signal. Hence, various user applications may have improved message passing performance as delays associated with conventional system calls and ring transitions are bypassed. The network processing stack software 210 may then further communicate with the NIC 140 to physically transmit and receive messages via the network to other computer nodes.

Such a system and method consistent with embodiments herein may also be utilized in a virtual computing environment. A virtual computing environment may be established by software on the system 100 that enables the creation of separate virtual machines to operate on one physical system 100. The physical system 100 may be referred to as the host having a host operating system, host drivers, and host hardware. A virtual system may include a guest operating system, guest applications, guest drivers, and virtualized hardware for each virtual system that acts like the stand alone physical system 100. A user of the physical system 100 may install one or more guest operating systems for one or more virtual systems and guest applications as memory and disk space of the physical system permit.

Application performance in such a virtualized environment may include multiple ring transitions. For instance, multiple ring transitions involved with message passing when crossing from a guest application to a guest operating system, and then from the guest operating system to a virtual memory monitor may be bypassed and a corresponding improvement in performance for message passing applications may be realized in the virtualized environment as well.

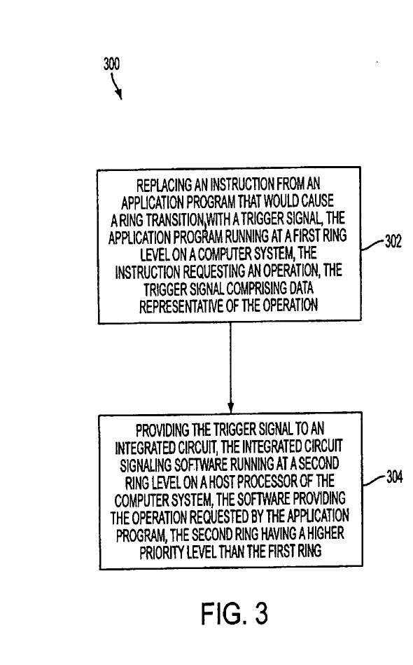

FIG. 3 is a flow chart of exemplary operations 300 consistent with an embodiment. Operation 302 may include replacing an instruction from an application program that would cause a ring transition with a trigger signal, the application program running at a first ring level on a computer system, the instruction requesting an operation, the trigger signal comprising data representative of the operation. Operation 304 may include providing the trigger signal to an integrated circuit, the integrated circuit signaling software running at a second ring level on a host processor of the computer system, the software providing the operation requested by the application program, the second ring level having a higher priority level than the first ring level.

It will be appreciated that the functionality described for all the embodiments described herein may be implemented using hardware, firmware, software, or a combination thereof. For example, the functionality provided by the IC 160 of FIG. 2 may alternatively be performed by a dedicated processor that accesses machine readable program instructions on any variety of machine readable media of the system to perform operations consistent with those performed by the IC 160.

Thus, in summary, one embodiment may comprise an apparatus. The apparatus may comprise an integrated circuit capable of receiving a trigger signal to bypass a ring transition and perform a requested operation of an application program. The integrated circuit may further be capable of signaling software running at a second ring level on a host processor of the apparatus in response to the trigger signal, the software providing the operation requested by the application program, the second ring level having a higher priority level than the first ring level.

Another embodiment may comprise a system. The system may comprise a network interface card capable of being coupled to a bus. The network interface card may comprise an integrated circuit. The integrated circuit may be capable of receiving a trigger signal to bypass a ring transition and perform a requested operation of an application program. The integrated circuit may further be capable of signaling software running at a second ring level on a host processor of the system in response to the trigger signal, the software providing the operation requested by the application program, the second ring level having a higher priority level than the first ring level.

Yet another embodiment may include an article. The article may comprise a machine readable medium having stored thereon instructions that when executed by a machine results in the following: replacing an instruction from an application program that would cause a ring transition with a trigger signal, the application program running at a first ring level on a computer system, the instruction requesting an operation, the trigger signal comprising data representative of the operation; and signaling software running at a second ring level on a host processor of the computer system in response to the trigger signal, the software providing the operation requested by the application program, the second ring level having a higher priority level than the first ring level.

Advantageously, in these embodiments, bypassing a ring transition decreases latency attributable to such ring transitions. For example, the time to perform a conventional system call requiring a ring transition from a user-mode application to a higher privileged Input/Output driver stack may consume 5,300 ns of processor time. Utilizing the bypass method and system consistent with embodiments detailed herein, this time may be reduced to about 250 ns with un-cached write to IOH implementations and reduced even further to about 120 ns with IOH cache snooping implementations. Future host processors may be able to further reduce such overhead times to about the same overhead as a L1 cache miss by moving the functionality to the un-core of the host processor. The embodiments herein may also enable cross processor core communication from application programs to partitioned or isolated processor cores without the overhead of both a ring transition and an inter-processor interrupt.

Furthermore, system call code that may otherwise pollute the cache memory of the host processor may be avoided. Removal of system calls and ring transitions removes a bottleneck for various processor intensive functions such on-processor network protocol processing for permitting communication between various devices coupled to a network. Furthermore, dedicated networking offload devices may be avoided as such functionality may be efficiently handled by the host processor.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method for bypassing a ring transition, said method comprising:
replacing an instruction from an application program that would cause a ring transition with a trigger signal, said application program running at a first ring level on a computer system, said instruction requesting an operation, said trigger signal comprising data representative of said operation; and
providing said trigger signal to an integrated circuit, said integrated circuit signaling software running at a second ring level on a host processor of said computer system, said software providing said operation requested by said application program, said second ring level having a higher priority level than said first ring level.

2. The method of claim 1, wherein said software comprises network processing stack software and said operation comprises an input/output operation.

3. The method of claim 1, wherein said trigger signal further comprises data identifying said application program.

4. The method of claim 1, wherein said signaling operation comprises interrupting said software running at said second ring level on said host processor.

5. An apparatus comprising:
an integrated circuit capable of receiving a trigger signal to bypass a ring transition and perform a requested operation of an application program, said integrated circuit further capable of signaling software running at a second ring level on a host processor of said apparatus in response to said trigger signal, said software providing said operation requested by said application program, said second ring level having a higher priority level than said first ring level.

6. The apparatus of claim 5, wherein said software comprises network processing stack software and said operation comprises an input/output operation.

7. The apparatus of claim 5, wherein said first ring level is Ring 3 and said second ring level is Ring 0.

8. The apparatus of claim 5, wherein said trigger signal comprises data identifying said application program.

9. The apparatus of claim 5, wherein said integrated circuit is capable of receiving a plurality of said trigger signals, wherein said integrated circuit is further capable of encoding said plurality of trigger signals into an associated plurality of data elements representative of an identity of said application program and said requested operation, wherein said integrated circuit is further capable of storing said data elements in a queue, and wherein said integrated circuit is further capable of said signaling of said software running at said second ring level on said host processor in response to said data elements in said queue.

10. A system comprising:
a network interface card capable of being coupled to a bus, said network interface card comprising an integrated circuit capable of receiving a trigger signal to bypass a ring transition and perform a requested operation of an application program, said integrated circuit further capable of signaling software running at a second ring level on a host processor of said system in response to said trigger signal, said software providing said operation requested by said application program, said second ring level having a higher priority level than said first ring level.

11. The system of claim 10, wherein said software comprises network processing stack software and said operation comprises an input/output operation.

12. The system of claim 10, wherein said first ring level is Ring 3 and said second ring level is Ring 0.

13. The system of claim 10, wherein said trigger signal comprises data identifying said application program.

14. The system of claim 10, wherein said integrated circuit is capable of receiving a plurality of said trigger signals, wherein said integrated circuit is further capable of encoding said plurality of trigger signals into an associated plurality of data elements representative of an identity of said application program and said requested operation, wherein said integrated circuit is further capable of storing said data elements in a queue, and wherein said integrated circuit is further capable of said signaling of said software running at said second ring level on said host processor in response to said data elements in said queue.

15. The system of claim 14, wherein said software comprises network processing stack software and said operation comprises an input/output operation, and wherein said network interface card facilitates communication to and from said system with other nodes capable of communicating with said network interface card in response to said input/output operation.

16. An article comprising:
a machine readable medium having stored thereon instructions that when executed by a machine results in the following:
replacing an instruction from an application program that would cause a ring transition with a trigger signal, said application program running at a first ring level on a computer system, said instruction requesting an operation, said trigger signal comprising data representative of said operation; and
signaling software running at a second ring level on a host processor of said computer system in response to said trigger signal, said software providing said operation requested by said application program, said second ring level having a higher priority level than said first ring level.

17. The article of claim 16, wherein said software comprises network processing stack software and said operation comprises an input/output operation.

18. The article of claim 16, wherein said first ring level is Ring 3 and said second ring level is Ring 0.

19. The article of claim 16, wherein said trigger signal comprises data identifying said application program.
